(19) United States
(12) Patent Application Publication
(10) Pub. No.: US 2015/0356597 A1
(43) Pub. Date: Dec. 10, 2015

(54) Correlating Online Content Distribution to Offline Activity

(71) Applicant: Google Inc., Mountain View, CA (US)

(72) Inventors: Shobhit Saxena, Sunnyvale, CA (US); David Owen Shanahan, Sunnyvale, CA (US); Philip A. McDonnell, San Francisco, CA (US); Vinod Kumar Ramachandran, Sunnyvale, CA (US); Shibani Sanan, Saratoga, CA (US)

(21) Appl. No.: 14/300,085

(22) Filed: Jun. 9, 2014

(51) Int. Cl. G06Q 30/02; H04L 29/08

(52) U.S. Cl. CPC G06Q 30/0246; H04L 67/22

(57) ABSTRACT

Example processes may include identifying online activity associated with content from a content provider; determining a first set of identification information, where the first set of identification information identifies users corresponding to the identified online activity associated with the content from the content provider; transmitting the first set of identification information to a first service and receiving, in return, a second set of different identification information; transmitting items of the second set of different identification information to a second different service and receiving, in return, aggregated offline transaction information corresponding to a set of transactions for users that are included in the second set of different identification information; attributing transactions indicated by the aggregated offline transaction information; and providing a report to the content provider that is based on the aggregated offline transaction information.

### TECHNICAL FIELD

This disclosure relates generally to correlating online content distribution to offline activity.

### BACKGROUND

The Internet provides access to a wide variety of resources. For example, video, audio, and Web pages are accessible over the Internet. These resources present opportunities for other content (e.g., advertisements or “ads”) to be provided along with the resources. For example, a Web page can include slots in which ads can be placed.

Merchants typically pay money for ad placement. Merchants often attempt to allocate their limited resources (e.g., money) to methods of content distribution that provide an overall benefit, such as an increased number of conversions. One type of conversion is an offline purchase (e.g., a purchase in a “brick and mortar” store). Merchants may wish to associate online advertisements with offline purchases so that they can determine the effectiveness of their online advertising. At the same time, safeguarding user-privacy is a primary concern.

### SUMMARY

Example processes may include the following: identifying online activity associated with content from a content provider; determining a first set of identification information, where the first set of identification information identifies users corresponding to the identified online activity associated with the content from the content provider; transmitting the first set of identification information to a first service and receiving, in return, a second set of different identification information, where an entry in the second set of different identification information corresponds to an undetermined entry in the first set of identification information and where receiving includes not receiving an indication of which entry in the second set of different identification information corresponds to which particular entry in the first set of identification; transmitting items of the second set of different identification information to a second different service and receiving, in return, aggregated offline transaction information from the second service, aggregated offline transaction information corresponding to a set of transactions for users that are included in the second set of different identification information; attributing transactions indicated by the aggregated offline transaction information with the identified online activity; and providing a report to the content provider that is based on the aggregated offline transaction information. The example processes may include one or more of the following features, either along or in combination.

The first set of identification information may include identifiers associated with users that interacted with a particular advertisement. The first set of identification information may include hashed e-mail addresses of users that clicked on a particular advertisement. The example processes may include transmitting a merchant identifier to the second service and/or transmitting a date range to the second service. The second set of different identification information may be a shuffled set relative to the items of the first set of identification information.

The example processes may include transmitting a portion of the items of the second different identification information to multiple different second services, and receiving a respective portion of the aggregated transaction information from each of the respective second services.

Two or more of the features described in this disclosure, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features, objects, and advantages will be apparent from the description and drawings, and from the claims.

### DESCRIPTION OF THE DRAWINGS

FIG. 1 is a block diagram of an example network environment on which the processes described herein may be implemented.

FIG. 2 is a flowchart showing an example of a process for correlating online content distribution to offline activity.

FIG. 3 is an example of a graphical user interface on which transaction information may be presented.

FIG. 4 is an example of a computer system on which the processes described herein may be implemented.

### DETAILED DESCRIPTION

Content, such as advertising, may be provided to network users based, e.g., on demographics, keywords, language, and interests. For example, advertising may be associated with one or more keywords that are stored as metadata along with the ad. A search engine, which operates on the network, may receive input from a user. The input may include one or more of the keywords. A content management system, which serves ads, may receive the keywords from the search engine, identify the ad as being associated with one or more of the keywords, and output the ad to the user, along with content that satisfies the initial search request. The content and the ad are displayed on a computing device. When displayed, the ad is incorporated into an appropriate slot on a results page. The user may select the ad by clicking-on the ad. In response, a hyperlink associated with the ad directs the user to another Web page. For example, if the ad is for ABC Travel Company, the Web page to which the user is directed may be the home page for ABC Travel Company. This activity is known as click-through. In this context, a “click” is not limited to a mouse click, but rather may include a touch, a programmatic selection, or any other interaction by which the ad may be selected. The content management system may charge a merchant for every click on an advertisement.

A content auction may be run by the content management system to determine which content is to be output in response to an input, such as one or more keywords. In the auction, content providers may bid on specific keywords (which are associated with their content). For example, a sporting goods ads provider may associate words such as “baseball”, “football” and “basketball” with their ads. The content provider may bid on those keywords in the content auction, typically on a cost-per-click (CPC) basis. The content provider's bid is an amount (e.g., a maximum amount) that the provider will pay in response to users clicking on their displayed content. So, for example, if a content provider bids five cents per click, then the content provider may pay five cents each time their content is clicked-on by a user, depending upon the type of the auction. In other examples, payment need not be on a CPC basis, but rather may be on the basis of other actions (e.g., an amount of time spent on a landing page, a purchase, and so forth).

Bidding in a content auction typically takes place against other content providers bidding for the same keywords. So, for example, if a user enters keywords into a search engine (to perform a search for related content), the content management system may select content items from different content providers, which are associated with those same keywords or variants thereof. The content auction is then run (e.g., by the content management system) to determine which content to serve along with the search results (or any other requested content). Typically, the winner of the content auction obtains the most preferred slots on a results page. The winner may be decided, e.g., based on bidding price, relevance of the keywords to content, and other factors.

Merchants' budgets are limited. Accordingly, it may benefit merchants to have a way to allocate that budget in order to achieve an increased return on investment (ROI) from their online advertising. In this regard, merchants often expect that their online ads will generate both online and offline transactions. While the correlation between an ad click and an online purchase may be readily discernible by the content management system, the correlation between an ad click and an offline purchase may not be readily discernible by the content management system.

Accordingly, described herein are example processes for correlating online content distribution to offline activity. For example, the online content distribution may include online advertising and the offline activity may include purchases or other activities that occur offline. The example processes described herein may be used to determine the effectiveness of the online advertising based on a measurement of offline activity that can be correlated to the online advertising. For example, using the processes described herein, it is possible to infer a correlation between an online advertising campaign and offline activities that occur within a time period following, or during, the online advertising campaign. An advertiser may use the information obtained in this manner to determine the effectiveness of the online advertising campaign and, thus, whether to modify, to continue with, or to discontinue the online advertising campaign. The effectiveness of the online advertising campaign may be based also on online activities, such as online purchases.

The following examples are described in the context of online advertising; however, the systems and processes described herein are applicable to any appropriate content. In this regard, the term “advertisement” or “ad” as used herein may refer to a single advertisement or to multiple advertisements. For example, the term may refer to all of the advertisements that are part of an advertising campaign.

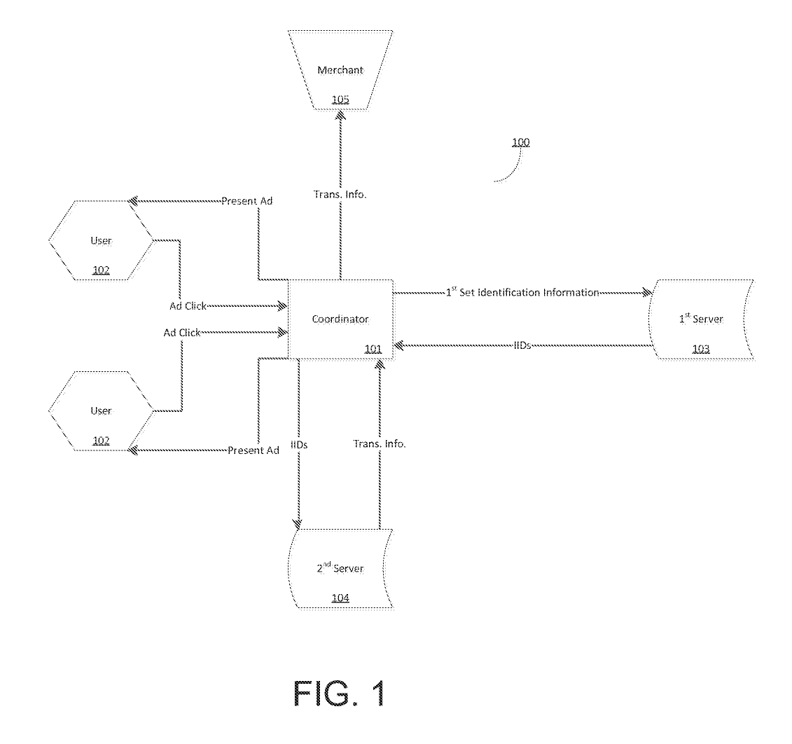

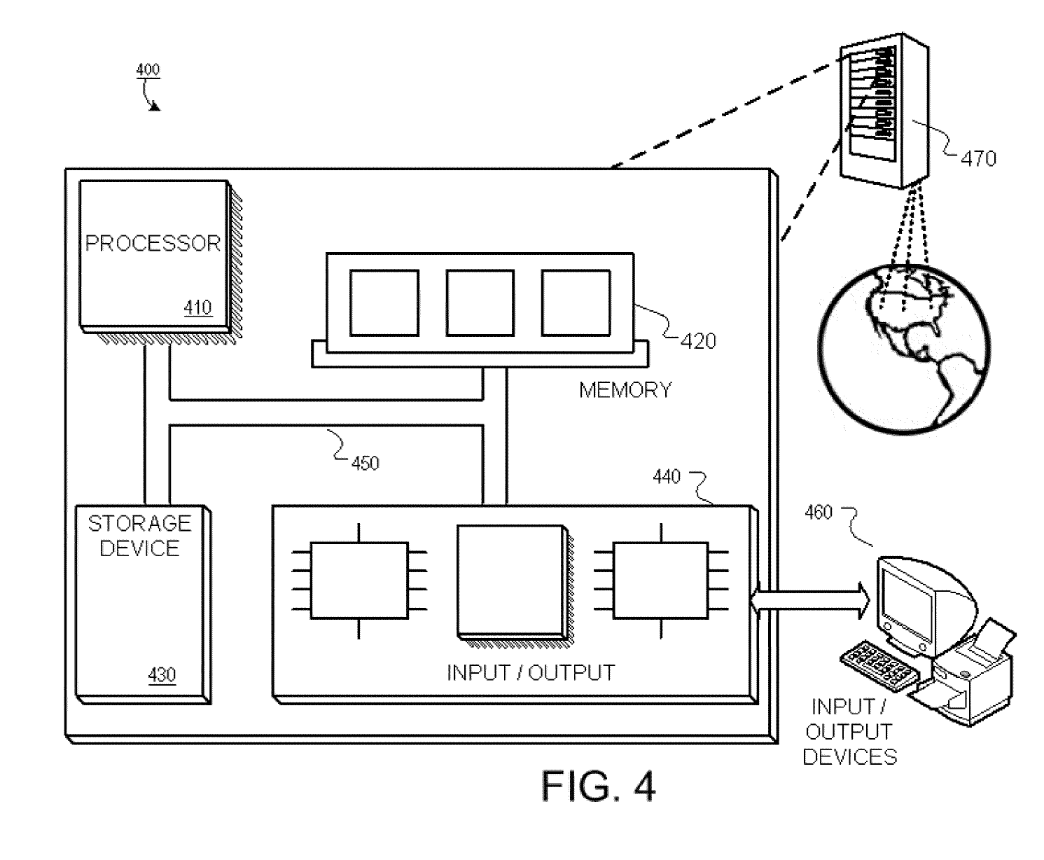

FIG. 1 shows an example implementation of a network environment 100 on which the processes described may be implemented. Any of the entities of FIG. 1 may be implemented, for example, as one or more servers or processing devices, such as those described below with respect to FIG. 4. The designations given to these entities are for illustrative purposes and are non-limiting.

Coordinator 101 may include a content management system, such as the content management system described above. In some implementations, coordinator 101 includes one or more processing devices that are configured to select content, such as ads, to distribute, e.g., to incorporate into online ad slots. The ads may be selected based on input keywords or other appropriate information provided by a user. In this example, a user 102 may include, for example, an individual, a household, a corporate entity, or a specific computing device. Coordinator 101 is also configured to identify users 102 that clicked on ads. In some implementations, coordinator 101 identifies each user 102 by the user's e-mail address; however, other appropriate types of identification information may also be used. The users may provide the coordinator with their e-mail addresses and also with permission beforehand to use their e-mail addresses for identification purposes. In some implementations, (after appropriate user permission has been given) coordinator 101 identifies users logged into the coordinator's 101 services when those users clicked on the ad. Accordingly, users that are not logged-in may not be identified. In some implementations, both logged-in and logged-out users may be identified.

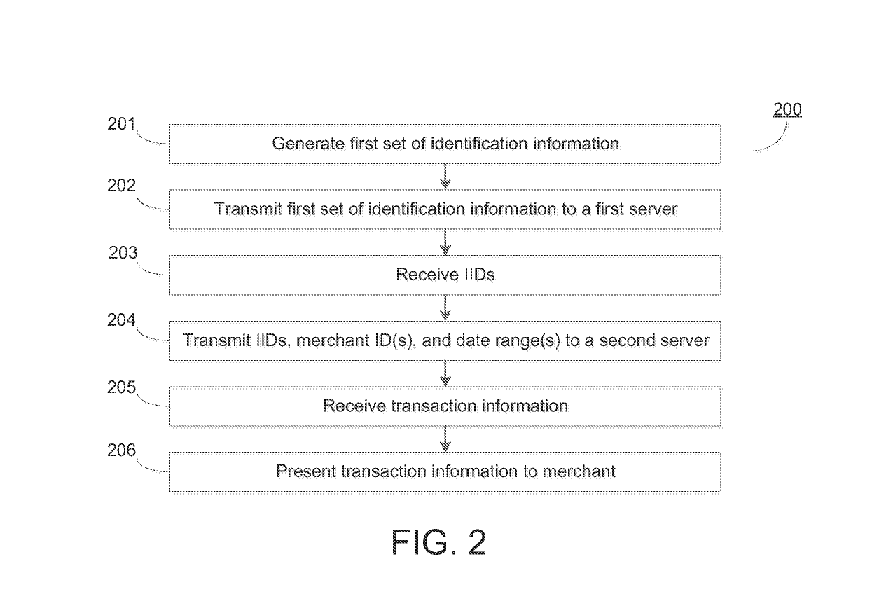

Coordinator 101 may be communicatively connected, e.g., via one or more networks (not shown), to a first server 103 and to a second server 104. In some implementations, the first and second servers each correspond to one or more servers, or are implemented in the same physical device, examples of which are described below with respect to FIG. 4. Coordinator 101 is configured to communicate (e.g., over the network) with these servers. For example, the coordinator 102 may be configured to communicate with first server 103 to obtain transaction information from second server 104, as described below with respect to process 200 of FIG. 2. As described in more detail below, the transaction information may include information the correlates online activity to offline activity, e.g., that coordinates online advertising to offline purchases. Coordinator 101 may transmit this transaction information to a merchant 105. Merchant 105 may be, e.g., a retailer that advertises online via coordinator 101 and that operates one or more brick-and-mortar stores and online stores.

FIG. 2 shows an example implementation of a process 200 for obtaining transaction information, such as that described above. In example operation 201, a first set of identification information may be generated. For example, the first set of identification information may be generated by coordinator 101. The first set of identification information may include, for example, a plurality of e-mail addresses (or a plurality of hashed e-mail addresses) representing users that clicked on a particular ad within a specified date range. The date range may be specified by the coordinator and may be adjusted as appropriate. As noted, in some implementations, the first set of identification information may reflect less than all users who clicked-on an ad. This may be because, for example, some users were not signed into the coordinator's services when they clicked on an advertisement.

In example operation 202, the first set of identification information may be transmitted to first server 103. For example, the first set of identification information may be transmitted by the coordinator to first server 103. In this example, first server 103 is configured to associate items of the first set of identification information (e.g., e-mail addresses) with intermediate IDs (“IIDs”). An IID may be an identifier that is distinct from an associated e-mail address and an associated credit ID (e.g., individual-, corporate-, or household-specific identifiers assigned by credit bureaus). The purpose of using IIDs is typically to protect user-privacy by inhibiting the coordinator from discovering credit IDs and inhibiting the purchase data provider (discussed later) from discovering e-mail addresses. The information on the server may be provided by a third-party ID provider. With appropriate user permission in place, an ID provider is able to associate e-mail addresses (and associated IIDs) with credit Ds. In some implementations, the ID provider does not provide information to the coordinator other than the IIDs.

In some implementations, the first set of identification information contains e-mail addresses and the server 103 contains e-mail addresses and associated IIDs. The server 103 may associate the former e-mail addresses with IIDs by matching those e-mail addresses with e-mail addresses already represented on the server, and then looking-up the associated IIDs.

In an example implementation, both the e-mail addresses in the coordinator's first set of identification information and those present on the server 103 are hashed. The hash inhibits the server from determining those e-mail addresses that are represented in the first set of identification information but not represented in the server. For example, the first set of identification information may contain two-hundred e-mail addresses but the server may contain only fifty e-mail addresses (and fifty associated IIDs). The server determines which e-mail addresses are represented in both the first set of identification information and the server by comparing the hashed values. If two hashed values are identical, then the server may use a lookup table to determine the associated IID. The server cannot generally determine the other e-mail addresses.

In example operation 203, the IIDs that are associated with the items of the first set of identification information are received. For example, the IIDs may be received by coordinator 101 after being transmitted by the server 103.

Example implementations include measures that inhibit the coordinator from determining a one-to-one association between items of the first set of identification information and IIDs, thereby protecting user privacy. In a first example, the server's data (e.g., hashed e-mail addresses and associated IIDs) may be provided by one or more ID providers rather than the coordinator. In a second example, the server may be configured to only return IIDs if the first set of identification information includes a defined (e.g., a minimum) number of items. The defined number may be set at, for example, fifty. In a third example, the server may be configured to only return a defined (e.g., a minimum) number of IIDs. For example, assume that a coordinator's first set of identification information contains 100 e-mail addresses and the ID provider has IIDs associated with 49 of these e-mail addresses. If the defined number is set at 50, then the server may return an error message. On the other hand, if the defined number is set at 40, then the server may return IIDs and possibly the e-mail addresses associated with those IIDs. In a fourth example, the IIDs may be shuffled before being transmitted to the coordinator. For example, if the first set of identification information is a list containing fifty hashed e-mail addresses, the ID provider may return fifty IIDs in a different order. In a fifth example, the server may be configured to return an error message if subsequently-transmitted first sets of identification information differ by only a small number of e-mail addresses. Otherwise, for example, if an earlier first set of identification information contained 50 e-mail addresses and a later first set of identification information contained 51 e-mail addresses (and the server has IIDs associated with all of these e-mail addresses), the coordinator could infer that the additional IID is associated with the additional e-mail address.

In example operation 204, the IIDs, merchant ID(s), and date range(s) may be transmitted to a purchase data provider represented by second server 204. For example, the coordinator may transmit the IIDs, merchant ID(s), and date range(s) to the purchase data provider. A merchant ID is typically a merchant-specific identifier and a single merchant may have multiple merchant Ds. The purchase data provider may associate the IIDs with credit Ds and user-specific transactions that occur at one or more merchant Ds. The purchase data provider may generate transaction information based on the coordinators' transmission.

The date range is typically chosen to account for users that purchase a product some period of time after clicking on an advertisement. For example, the date range may be the date of click plus thirty days. The date range is typically specified by the merchant. In the case of multiple clicks by a single user, the coordinator typically ensures that any resulting transactions are not double counted. This may be accomplished by, for example, shortening the date range of earlier clicks. For example, assume that Click 1 occurred on Day 1, Click 2 occurred on Day 6, a transaction (e.g., a purchase) occurred on Day 7, and that the date range is the date of click plus ten days. The coordinator may ensure that the transaction is not double counted by shortening the date range associated with Click 1 to the date of click plus four days. As a result, the transaction would be solely attributed to Click 2.

In example operation 205, transaction information is received. For example, the coordinator may receive the transaction information. The transaction information may be transmitted by the second server 204 over the network. The transaction information may include, for example, the time and value of each offline transaction made by the IIDs at a particular merchant's store within the specified date ranges. Generally, however, the transaction information includes aggregated metrics such as (a) the number of unique users that made purchases at a particular merchant's stores; (b) the number of unique transactions made by those users; and/or (c) the total aggregate transaction value. In some implementations, the transaction information includes online transaction information. The transaction information may be split by distribution channel (e.g., offline purchases, online purchases, or phone purchases). The use of aggregated transaction information inhibits the coordinator from associating particular transaction information with particular IIDs, thereby protecting user privacy.

A single purchase data provider might not possess transaction information associated with every single IID. This may be because, for example, users made purchases using different purchase data providers. In an example implementation, the coordinator transmits some or all of the IIDs to multiple purchase data providers. The coordinator may then receive multiple sets of transaction information. In another example implementation, the coordinator transmits some or all of the IIDs to one purchase data provider and may then use the received transaction information to estimate the total transaction information across all purchase data providers.

Example implementations include measures that inhibit the coordinator from determining user-specific transaction information, thereby protecting user privacy. In a first example, the purchase data provider does not return transaction information unless the coordinator's first set of identification information contains a defined (e.g., a minimum) number of IIDs. In a second example, the purchase data provider will not return transaction information if a coordinator's subsequent first sets of identification information differ by only a small number of users.

In an example implementation, the coordinator may transmit the same IIDs to a purchase data provider multiple times. For example, assume that a coordinator generates the hashed e-mail addresses of all users that clicked on an advertisement on Day 1. The coordinator transmits these hashed e-mail addresses to a server and subsequently receives shuffled IIDs. The coordinator provides a purchase data provider with these IIDs, a merchant ID, and a date range. The coordinator then receives transaction information. On Day 2, the coordinator provides the purchase data provider with these same IIDs, a merchant ID, and a date range. The coordinator then receives new transaction information. One advantage of this example implementation is that the coordinator need not repeatedly obtain new sets of IIDs. Another advantage is that the coordinator may determine the amount of time between ad clicks and offline purchases without being able to associate particular offline purchases with particular IIDs, thereby protecting user-privacy. In another example implementation, the coordinator transmits a set of IIDs to the purchase data provider and automatically receives new transaction information on a recurring (e.g., daily) basis.

In example operation 206, the transaction information may be presented to a particular merchant. For example, the coordinator may present the transaction information to a particular merchant. The coordinator may additionally or alternatively present transaction information that is based on the transaction information received by the second server 104. For example, this transaction information may represent the sum of multiple pieces of transaction information received from different purchase data providers. The coordinator may also make statements or recommendations based on the transaction information. For example, the coordinator may recommend that a merchant allocate money to an advertisement that was more cost-effective in generating offline transactions. The information may be presented in a graphical user interface.

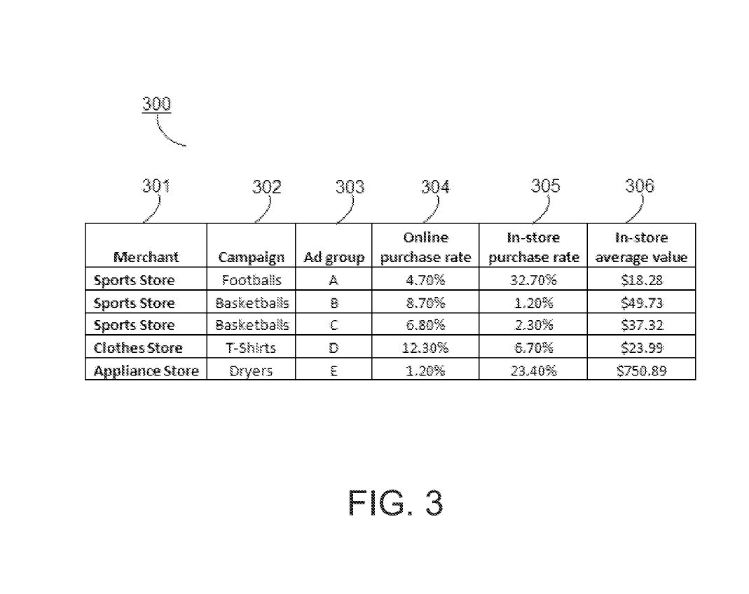

FIG. 3 is shows an example graphical user interface 300 (“GUI”) that may be used to report transaction information to a merchant, such as an online advertiser. In example GUI 300, the fifth column 303 and sixth column 306 provide aggregated transaction information associated with the ad groups listed in the third column 303. The ad groups may be specific to a particular merchant's (listed in the first column 301) advertising campaign (listed in the second column 302). The online purchase rate is also provided in the fourth column 304. The GUI may be created using any appropriate method or process.

Statistics and estimations may be used to extrapolate from incomplete data. For example, consider the case where (1) 1000 users clicked on an ad; (2) 100 users were logged in at the time of clicking on the ad; (3) the coordinator obtains 100 IIDs associated with those users; (4) the coordinator transmits these IDs to a purchase data provider that has a 50% market share; and (5) the purchase data provider indicates that the associated transactions amounted to $1000. In this example scenario, the coordinator could estimate a total transaction value of $20,000 [(1000/100)×(1/0.5)×$1000]. An advertiser may use this information as a factor in determining the effectiveness of an online advertising campaign and, thus, whether to modify, to continue with, or to discontinue the campaign.

As describe above with respect to FIG. 2 an example was shown of a process 200 for obtaining and using transaction information. In some implementations, the process can be as follows. The process can begin with the identification of online activity associated with content from a content provider. As described above, the online activity can represent interactions (e.g., clicks) of one or more users with content (e.g., advertisements) of a content provider (e.g., an advertiser). The process can include determining a first set of identification information, wherein the first set of identification information identifies users corresponding to the identified online activity associated with the content from the content provider. For example the first set of identification information can be of the form of email addresses associated with respective users that interacted with the content of the content provider.

The first set of identification information can be transmitted to a first service (e.g., an independent identification provider, a bridge provider or entity associated therewith) and, in return, a second set of different identification information is received. As described above the second different set of identification information can be a list of identifiers that are linked to the identifiers included in the first set of identification information. In some implementations, an entry in the second set of different identification information corresponds to an undetermined entry in the first set of identification information (e.g., they are shuffled). In some implementations, receiving includes not receiving an indication of which entry in the second set of different identification information corresponds to which particular entry in the first set of identification.

Some or all of the second set of different identification information is transmitted to a second different service (e.g., a purchase data provider, payment card processor or the like) and, in return aggregated offline transaction information is received from the second service that corresponds to a set of transactions for users that are included in the second set of different identification information. In some implementations, the aggregate information includes the number of unique users that made purchases (from the set), the number of unique transactions from the users, the total transaction value, or anonymized individual transaction values.

Transactions indicated by the aggregated transaction information are attributed to the identified online activity. For example, transactions and transaction values can be attributed to the clicks, enabling a determination of return on investment or other performance metric calculations (e.g., statistics and metrics as discussed above). In some implementations, a report can be provided to the content provider that is based on the offline transaction information and or performance metrics that are determined based on the aggregate transaction information.

As can be appreciated from the above description of the process, the entity that identifies the interaction data, can be provided with aggregate information for transactions associated with users that are known to the entity, without providing specific transaction information for any given user.

FIG. 4 is block diagram of an example computer system 400 that may be used in performing the processes described herein, and that may be used to implement any of the processing devices (e.g., servers) described herein. Example system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 460.

The coordinator, first server, and second server can include instructions that upon execution cause one or more processing devices to carry out the processes and functions described above. Such instructions can include, for example, interpreted instructions, such as script instructions, e.g., JavaScript or ECMAScript instructions, or executable code, or other instructions stored in a computer readable medium. The coordinator, first server, and second server can be distributively implemented over a network, such as a server farm, or can be implemented in a single computer device.

Example computer system 400 is depicted as a rack in a server 470 in this example. As shown the server may include multiple such racks. Various servers, which may act in concert to perform the processes described herein, may be at different geographic locations, as shown in the figure. The processes described herein may be implemented on such a server or on multiple such servers. As shown, the servers may be provided at a single location or located at various places throughout the globe. The servers may coordinate their operation in order to provide the capabilities to implement the processes.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

In this regard, various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads and GUIs, generated according to the processes described herein may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Elements of different implementations described herein can be combined to form other implementations not specifically set forth above. Elements can be left out of the processes, computer programs, Web pages, etc. described herein without adversely affecting their operation. In addition, various separate elements can be combined into one or more individual elements to perform the functions described herein. The logic flows depicted in the figures do not require the particular order shown, or sequential order, to achieve desirable results. For example, after the coordinator transmits the first set of identification information to an ID provider, the ID provider (rather than the coordinator) may transmit the associated IIDs to the purchase data provider. The purchase data provider may then transmit the transaction information to the coordinator, the ID provider, or the merchant.

In some implementations, in addition or in lieu of the reporting of the aggregate information to the content providers, one or more automatic adjustments can be made to one more campaigns. For example, a campaign associated with the content sponsor (i.e., that is associated with the identified interactions by users) can be automatically adjusted in terms of its pricing (e.g., adjust a bid automatically) or targeting (e.g. adjusting one or more serving criteria associated with the campaign). Further one or more campaigns can be cancelled or paused based on the aggregate information.

Other implementations not specifically described herein are also within the scope of the following claims.

What is claimed is:

1. A method comprising:
identifying online activity associated with content from a content provider;
determining a first set of identification information, wherein the first set of identification information identifies users corresponding to the identified online activity associated with the content from the content provider;
transmitting the first set of identification information to a first service and receiving, in return, a second set of different identification information, wherein an entry in the second set of different identification information corresponds to an undetermined entry in the first set of identification information and wherein receiving includes not receiving an indication of which entry in the second set of different identification information corresponds to which particular entry in the first set of identification;
transmitting items of the second set of different identification information to a second different service and receiving, in return, aggregated offline transaction information from the second service, aggregated offline transaction information corresponding to a set of transactions for users that are included in the second set of different identification information;
attributing transactions indicated by the aggregated offline transaction information with the identified online activity; and
providing a report to the content provider that is based on the aggregated offline transaction information.

2. The method of claim 1, wherein the first set of identification information comprises identifiers associated with users that interacted with a particular advertisement.

3. The method of claim 1, wherein the first set of identification information comprises hashed e-mail addresses of users that clicked on a particular advertisement.

4. The method of claim 1, further comprising transmitting a merchant identifier to the second service.

5. The method of claim 1, further comprising transmitting a date range to the second service.

6. The method of claim 1, wherein the second set of different identification information is a shuffled set relative to the items of the first set of identification information.

7. The method of claim 1, further comprising:
transmitting a portion of the items of the second different identification information to multiple different second services, and receiving a respective portion of the aggregated transaction information from each of the respective second services.

8. The method of claim 1, wherein the report is also based on aggregated online transaction information.

9. One or more machine-readable storage devices storing instructions that are executable by one or more processing devices to perform operations comprising:
identifying online activity associated with content from a content provider;
determining a first set of identification information, wherein the first set of identification information identifies users corresponding to the identified online activity associated with the content from the content provider;
transmitting the first set of identification information to a first service and receiving, in return, a second set of different identification information, wherein an entry in the second set of different identification information corresponds to an undetermined entry in the first set of identification information and wherein receiving includes not receiving an indication of which entry in the second set of different identification information corresponds to which particular entry in the first set of identification;
transmitting items of the second set of different identification information to a second different service and receiving, in return, aggregated offline transaction information from the second service, aggregated offline transaction information corresponding to a set of transactions for users that are included in the second set of different identification information;
attributing transactions indicated by the aggregated offline transaction information with the identified online activity; and
providing a report to the content provider that is based on the aggregated offline transaction information.

10. The one or more machine readable storage devices of claim 9, wherein the first set of identification information comprises identifiers associated with users that interacted with a particular advertisement.

11. The one or more machine readable storage devices of claim 9, wherein the first set of identification information comprises hashed e-mail addresses of users that clicked on a particular advertisement.

12. The one or more machine readable storage devices of claim 9, wherein the operations comprise transmitting a merchant identifier to the second service.

13. The one or more machine readable storage devices of claim 9, wherein the operations comprise transmitting a date range to the second service.

14. The one or more machine readable storage devices of claim 9, wherein the second set of different identification information is a shuffled set relative to the items of the first set of identification information.

15. The one or more machine readable storage devices of claim 9, wherein the operations comprise:
transmitting a portion of the items of the second different identification information to multiple different second services, and receiving a respective portion of the aggregated transaction information from each of the respective second services.

16. A system comprising:
memory storing instructions that are executable; and
one or more processing devices to execute the instructions to perform operations comprising:
identifying online activity associated with content from a content provider;
determining a first set of identification information, wherein the first set of identification information identifies users corresponding to the identified online activity associated with the content from the content provider;
transmitting the first set of identification information to a first service and receiving, in return, a second set of different identification information, wherein an entry in the second set of different identification information corresponds to an undetermined entry in the first set of identification information and wherein receiving includes not receiving an indication of which entry in the second set of different identification information corresponds to which particular entry in the first set of identification;
transmitting items of the second set of different identification information to a second different service and receiving, in return, aggregated offline transaction information from the second service, aggregated offline transaction information corresponding to a set of transactions for users that are included in the second set of different identification information;
attributing transactions indicated by the aggregated offline transaction information with the identified online activity; and
providing a report to the content provider that is based on the aggregated offline transaction information.

17. The system of claim 16, wherein the first set of identification information comprises identifiers associated with users that interacted with a particular advertisement.

18. The system of claim 16, wherein the first set of identification information comprises hashed e-mail addresses of users that clicked on a particular advertisement.

19. The system of claim 16, wherein the operations comprise transmitting a merchant identifier to the second service.

20. The system of claim 16, wherein the operations comprise transmitting a date range to the second service.
